(19) United States
(12) Patent Application Publication
(10) Pub. No.: US 2005/0252184 A1
(43) Pub. Date: Nov. 17, 2005

(54) Reel

(75) Inventor: Glenn Robert Craig, Warwick (AU)

Correspondence Address: PALMER & DODGE, LLP;KATHLEEN M. WILLIAMS, 111 HUNTINGTON AVENUE, BOSTON, MA, 02199, US

(73) Assignee: Glenn Robert Craig and Jacqueline Craig

(21) Appl. No.: 11/145,322

(22) Filed: Jun. 3, 2005

Related U.S. Application Data
(63) Continuation of application No. PCT/AU03/01603, filed on Dec. 1, 2003.

(30) Foreign Application Priority Data
Dec. 3, 2002 (AU) 2002953066

(51) Int. Cl. A01D 75/30

(52) U.S. Cl. 56/7

(57) ABSTRACT

A reel for performing a working operation such as lawn moving, lawn renovating such as dethatching, or ground levelling. The reel comprises a central support such as a rigid cylinder, defining an axis of rotation of the reel. A plurality of bristles project outwardly of the central support. The outer ends of the bristles cooperate to define a generally cylindrical surface coaxial with the axis of rotation. The bristles are grouped in tufts which in turn are arranged in a spiral formation.

### FIELD OF THE INVENTION

This invention relates to a reel, and apparatus incorporating such a reel, for performing working operations.

The working operations are typically performed on a lawn or on the ground surface, although other operations are also envisaged.

### BACKGROUND ART

Lawncare involves maintenance such as regular mowing and periodic dethatching. This is particularly the case for lawns used as bowling greens, golf course fairways and putting greens.

With regard to lawn care for bowling greens, it is usual for the lawn to be cut regularly, possibly several times each day in an endeavour to maintain the lawn in an appropriate playing condition. Each cutting operation can also involve several passes over the lawn. Accordingly, the maintenance of a lawn in a playing condition can be a very time consuming procedure.

The need to make several passes over such a lawn during a mowing operation, and to mow the lawn several times each day, arises because of the nature of the equipment used for the mowing operation. Typically, a conventional reel mower is employed for the mowing operation, involving a driven horizontally mounted cutter reel incorporating a number of circumferentially spaced spiral blades. The cutter reel operates in conjunction with a cutter bar, Whereby blades of grass are sliced between the cutter bar and the spiral blades, moving relative to the cutter bar. Because of the circumferential spacing between the spiral reels, it is not possible for all blades of grass requiring cutting to be cut in a single pass. Consequently, several passes are required in order to provide a lawn in an appropriate playing condition.

The lawns also require renovation from time to time, which can involve dethatching or “verti-mowing”. The dethatching operation is usually performed using a separate machine to a reel mower, or alternatively a conventional reel mower modified by replacement of the cutter reel with an appropriate tool assembly for performing the necessary renovation operation.

It is against this background that the present invention has been developed.

### DISCLOSURE OF THE INVENTION

According to one aspect of the invention there is provided a reel for performing a working operation, the reel comprising a central support defining an axis of rotation of the reel, and a plurality of bristles projecting outwardly of the central support.

Preferably, the outer ends of the bristles cooperate to define a generally cylindrical surface coaxial with the axis of rotation.

The bristles may comprise wire bristles.

The bristles may be grouped in tufts.

The tufts of bristles may be arranged in a spiral formation.

Preferably, the outer surface of each tuft (defined by the tips of the bristle contained therein) is arcuate with a radius of curvature centred on the axis of rotation of the reel.

According to a second aspect of the invention, there is provided apparatus incorporating a reel according to the first aspect of the invention.

Preferably, the apparatus further comprises a body rotatably supporting the reel and a drive means for rotating the reel, the body being supported on two spaced apart ground-engaging means such as rollers, and the reel being horizontally disposed between the two ground-engaging means.

Preferably; the drive system comprises a motor carried on the body.

Preferably, the apparatus further comprises means for selectively adjusting the height of the reel relative to the two ground-engaging means.

Preferably, the apparatus can perform various functions, including lawn mowing, lawn renovating such as dethatching, ground levelling, sweeping, materials dispersal, and materials collection.

Where the apparatus is required to perform a mowing operation, it preferably has provision for accommodating a cutter bar which co-operates with the reel for shearing blades of glass therebetween.

According to a third aspect of the invention there is provided a cutter assembly comprising a reel according to a first aspect of the invention and a cutter bar cooperating with the reel. With this arrangement, the bristles and the cutter bar co-operate for shearing blades of grass therebetween.

According to a fourth aspect of the invention there is provided a mower incorporating a cutter assembly according to a second aspect of the invention.

According to a fifth aspect of the invention there is provided apparatus for renovating a lawn, characterised in that said apparatus incorporates a reel according to the first aspect of the invention.

The apparatus renovates a lawn by moving the rotating reel over the lawn to perform the renovation such as removal of thatch within the lawn. This may require that the reel be spaced at or above the ground surface in which the lawn is growing. The apparatus can also be used to aggressively renovate the lawn or indeed remove the lawn. In such an arrangement, the reel would typically a level such that it works below the level of the ground surface.

Preferably, the apparatus includes adjustment means for selectively adjusting the height of the reel with respect to the lawn undergoing renovation.

According to a sixth aspect of the invention there is provided ground working apparatus characterised in that the ground working apparatus incorporates a ground working tool comprising a reel according to the first aspect of the invention.

### BRIEF DESCRIPTION OF THE DRAWINGS

The invention will be better understood by reference to the following description of one specific embodiment thereof as shown in the accompanying drawings in which:

FIG. 1 is a schematic side view of apparatus according to a first embodiment, with the apparatus being configured to perform a lawn mowing operation;

FIG. 2 is a schematic perspective view of a reel forming part of the apparatus of FIG. 1;

FIG. 3 is a schematic end view of the reel of FIG. 2;

FIG. 4 is a schematic fragmentary view illustrating the apparatus performing a lawn mowing operation;

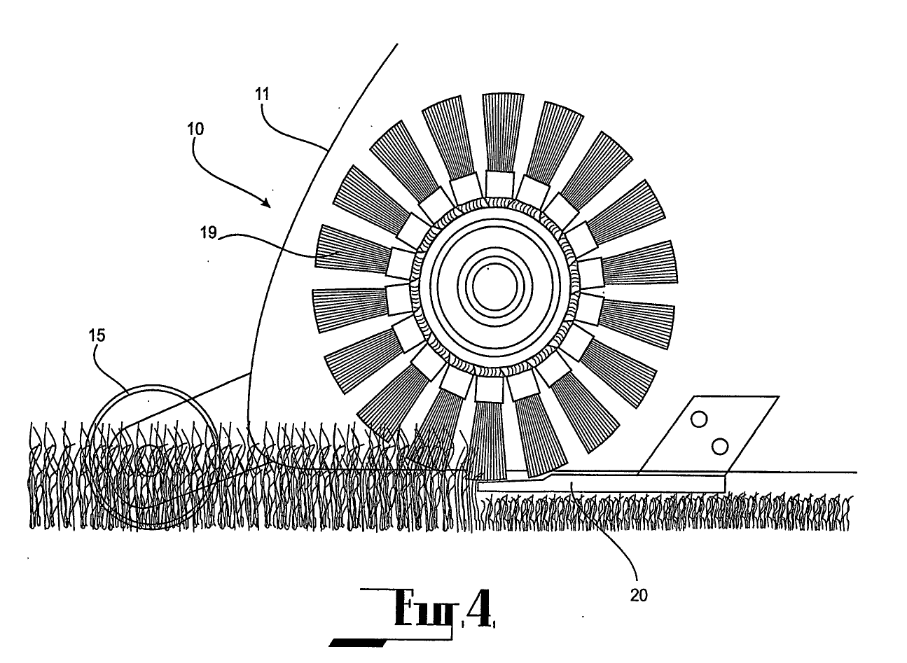

FIG. 5 is a schematic view of the apparatus configured to perform a dethatching operation.

### BEST MODE(S) FOR CARRYING OUT THE INVENTION

Referring to the drawings, the apparatus 10 according to the embodiment is of a construction similar to a conventional reel mower, comprising a body 11 incorporating a handle 13. The body 11 is supported on two ground-engaging means in the form of rollers, being a smaller front roller 15 and a larger rear roller 17. A horizontally disposed reel 19 is supported on the body 11 between the front and rear rollers 15, 17. The reel 19 is driven by way of a drive system which incorporates a motor 21. A mechanism (not shown) is provided for adjusting the height of the reel 19 relative to the rollers 15, 17.

The apparatus 10 can perform various functions, including lawn mowing, lawn renovating such as dethatching, and ground levelling.

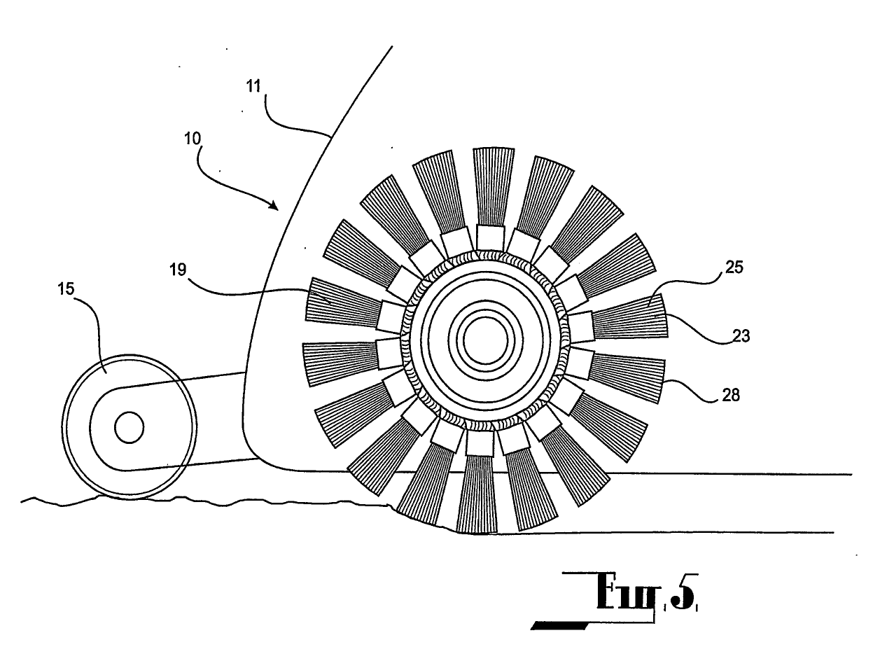

When the apparatus 10 is configured for lawn mowing operations, it is fitted with a cutter bar 20 which operates in association with the reel 19, as will be explained in more detail later. When the apparatus is set up for certain other operations including dethatching, the cutter bar 20 is removed (as shown in FIG. 5).

The reel 19 comprises a central support 21 defined by a rigid cylinder 22 closed at each end thereof by an end wall 24 from which a stub shaft 26 extends. The reel 19 is rotatably supported within the body 11 by way of the stub shafts 26. The reel 19 also includes means (not shown) for receiving rotational drive from the drive system.

The reel 19 further comprises a plurality of bristles 23 projecting outwardly from the central support 21. The bristles 23 are assembled into tufts 25, with each tuft having an inner end which is received and retained within a retaining socket 27 attached to the cylinder 22. In this embodiment, each bristle 23 is formed of steel wire, and each tuft 25 comprises a section of multi-strand steel cable such as wire rope.

A particularly simple and convenient way of forming the tufts 25 and the bristles 23 is to cut a length of wire rope into sections, with each section constituting one tuft.

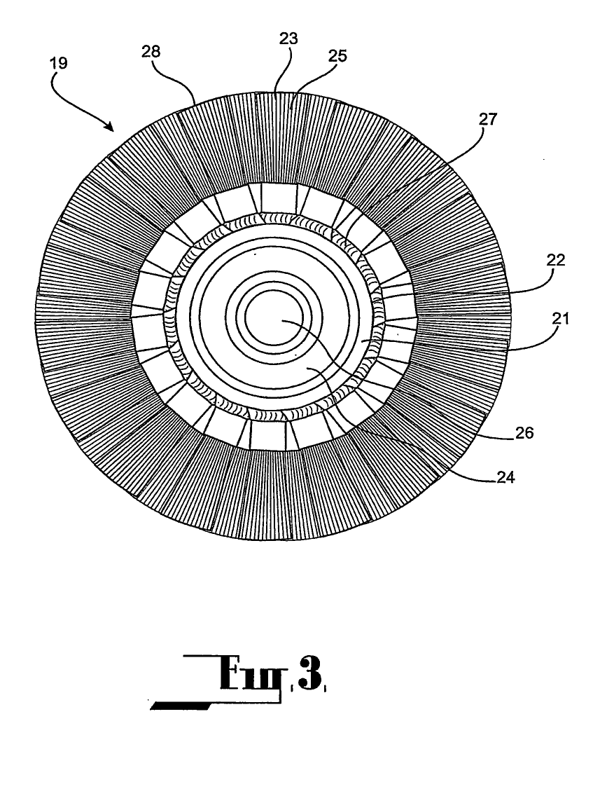

The outer tips of the bristles 23 in each tuft 25 cooperate to define an outer surface 28. Each outer surface 28 is curved, with the centre of curvature corresponding to the rotational axis of the reel 19. The tufts 25 are of substantially the same length such that their outer surfaces 28 generally occupy a substantially common cylindrical plane, as best seen in FIG. 3 of the drawings.

Conveniently, the curvation of the outer surfaces 28 is achieved by performing a rotary grinding operation on the reel 19.

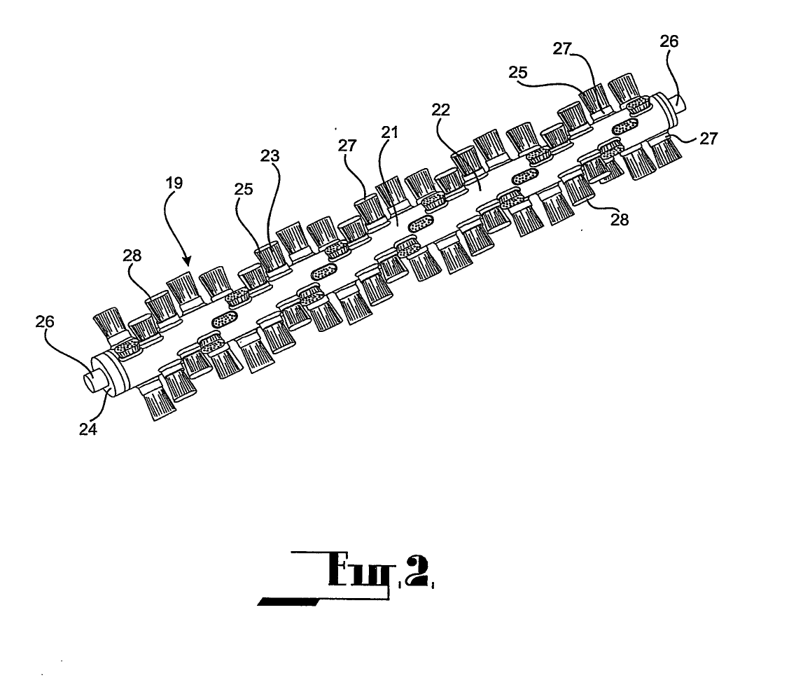

The tufts 25 are arranged in an array which provides a series of circumferentially spaced spiralling rows, as best seen in FIG. 2 of the drawings.

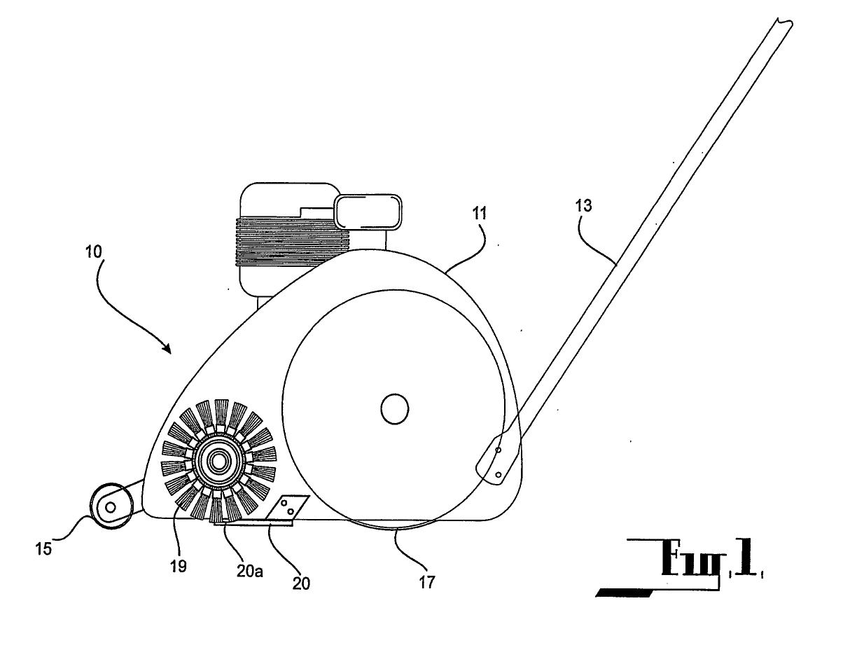

When the apparatus 10 is to perform a lawn mowing function, the reel 19 operates in association with a cutter bar 20, as alluded to earlier. The rotating reel 19 is positioned relative to the cutter bar 20 so as to sweep in close contact with the leading edge section of the cutter bar. Over a period of time, the cutter bar will wear to conform generally to the circular profile of the outer periphery of the reel, such wear being depicted in FIG. 1 of the drawings at zone 20a.

The lawn cutting operation is performed by subjecting the grass blades to a shearing action between the cutter bar 20 and the rotating bristles 23. More particularly, a grass blade can be carried by a respective one of the bristles 23 to the cutter bar 20 and then subjected to a shearing action by interaction between the bristle and the cutter bar as the bristle sweeps over the cutter bar during rotation of the reel. Because of the multitude of bristles 23 employed in the reel 19, there is little chance of any grass blade not being cut in a single pass of the reel. Consequently, a more efficient cutting operation is provided in comparison to that available with a conventional reel having spiral blades which requires at least several passes to perform an appropriate mowing operation.

The bristles 23 on the reel 19 also enhance the grass catching aspect of the mowing operation, as they tend to sweep the cut surface and thus carry cut grass towards a grass catching zone within the apparatus.

As mentioned above, the apparatus 10 according to the embodiment can perform working operations other than lawn mowing. One such operation is lawn renovation involving dethatching. To perform such an operation, the cutter bar 20 is removed from the apparatus, as shown in FIG. 5. The height of the reel 19 is then adjusted with respect to the front and rear rollers 15, 17 to the desired level according to the nature of the renovation operation to be performed. Where a light renovation is required, the reel 19 can be set relatively high to the lawn surface, with the result that the reel sweeps over the lawn surface to perform the light renovating procedure. On the other hand, where an aggressive renovation is desired, the reel 19 is lowered so as to more aggressively contact the lawn and possibly also soil beneath the lawn.

It has been found that the action of the rotating bristles 23 on the lawn provides a highly effective dethatching action.

The reel 19 can also be used to remove lawn from an area by appropriate setting of the level of the reel with respect to the ground. In such an instance, it is likely that the reel 19 would be set to a level below that of the actual ground surface.

While not shown in the drawings, the apparatus 10 can also be used to perform a ground working operation such as levelling. In such an application, the rotating reel is moved across the area to be worked to remove bumps and crests in the ground surface.

While the invention has been described with reference to one specific embodiment, it is not limited thereto. By way of example, while the reel 19 has been described with the tufts 25 of bristles arranged in spiralling rows, it should be understood that any other arrangement of tufts may be appropriate. Additionally, it should be understood that the bristles may not necessarily need to be assembled in tufts but rather could be individually carried on the support 21. Further, while the embodiment has been described with reference to bristles formed of steel wire, it should be understood that bristles of any other appropriate material may be employed.

Apparatus according to the invention may also be employed for other operations, including sweeping and materials dispersal (such as snow clearing) utilising the rotating reel. Additionally, apparatus according to the invention may be used for materials collection such as, for example, collection of debris on the ground. In such an application, the rotating reel would be passed over the ground to make contact with the debris and throw it into an associated collection receptacle.

Modifications and improvements may be incorporated without departing from the scope of the invention.

Throughout the specification, unless the context requires otherwise, the word “comprise” or variations such as “comprises” or “comprising”, will be understood to imply the inclusion of a stated integer or group of integers but not the exclusion of any other integer or group of integers.

1. An apparatus for performing a dethatching operation on an area of lawn, the apparatus comprising: a body, a dethatching reel mounted on the body for rotation about an axis, a drive means for rotating the dethatching reel about the axis; the dethatching reel comprising a plurality of bristles projecting outwardly therefrom and the drive means being adapted to rotate the reel such that the bristles operate below the level of the lawn to perform a dethatching operation.

2. The apparatus of claim 1 wherein the plurality of bristles define a generally cylindrical surface coaxial with the axis of rotation.

3. The apparatus of claim 1 wherein the bristles are grouped in tufts.

4. The apparatus of claim 3 wherein the tufts of bristles are arranged in a spiral formation.

5. The apparatus of claim 3 wherein the outer surface of each tuft, defined by the tips of the bristles contained therein, is arcuate.

6. The apparatus of claim 5 wherein the arcuate outer surface of each tuft has a radius of curvature centred on the axis of rotation of the reel.

7. The apparatus of claim 1 wherein the body is supported on two spaced apart ground-engaging means for movement in a direction of motion over the lawn area, the reel being disposed between the two ground-engaging means for contacting the lawn area.

8. The apparatus of claim 7 wherein the reel is disposed with the axis of rotation substantially horizontal and normal to the direction of motion.

9. The apparatus of claim 8 wherein the ground-engaging means comprise rollers.

10. The apparatus of claim 7 further comprising means for selectively adjusting the height of the reel relative to the two ground-engaging means.

11. The apparatus of claim 1 wherein the drive system comprises a motor carried on the body.

12. A dethatching apparatus comprising: a body, a leading ground-engaging means and a trailing ground-engaging means for supporting the body for movement in a direction of motion over a lawn area, a dethatching reel mounted on the body for rotation about an axis transverse to direction of motion of the body, a drive means for rotating the reel about the axis of rotation; the reel being disposed between the leading and trailing ground-engaged means, the reel comprising a plurality of bristles projecting outwardly therefrom and the drive means being adapted to rotate the reel such that the bristles operate at a level below the ground-engaging means thereby to in use perform a dethatching operation on the lawn area.

13. The dethatching apparatus of claim 12 wherein each ground-engaging means comprises a roller.

14. A method of dethatching an area of lawn including: driving a reel about an axis of rotation such that a plurality of bristles projecting outwardly from said axis operate below the level of the lawn to perform a dethatching operation.

15. The method of claim 14 wherein the bristles of the reel define a generally cylindrical surface coaxial with the axis of rotation.

16. The method of claim 15 wherein the bristles are grouped in tufts.

17. The method of claim 16 wherein the tufts of bristles are arranged in a spiral formation.

18. The method of claim 16 wherein the outer surface of each tuft defined by the tips of the bristle contained therein is arcuate.

19. The method of claim 18 wherein the arcuate outer surface of each tuft has a radius of curvature centred on the axis of rotation of the reel.

20. The method of claim 14 further including selectively adjusting the level of the reel with respect to the lawn area undergoing renovation to regulate the depth of operation of the bristles below the level of the lawn.
